(19) United States
(12) Patent Application Publication
(10) Pub. No.: US 2008/0171124 A1
(43) Pub. Date: Jul. 17, 2008

(54) All natural sweetener composition

(76) Inventors: Loren Miles, Van Nuys, CA (US); Chan Ma, Phillips Ranch, CA (US)

Correspondence Address: EPSTEIN BECKER & GREEN, P.C., 150 North Michigan Avenue, 35th Floor, Chicago, IL, 60601, US

(21) Appl. No.: 11/906,539

(22) Filed: Oct. 2, 2007

Related U.S. Application Data
(60) Provisional application No. 60/849,086, filed on Oct. 3, 2006.

(51) Int. Cl. A23L 1/09

(52) U.S. Cl. 426/548

(57) ABSTRACT

An all natural zero and low calorie sweetener composition is disclosed, which can be supplemented with calcium. The disclosed sweetener can be used in foodstuffs including food, beverages, and beverage products as a substitute for high calorie sweeteners along with calcium supplementation.

This application claims the benefit under 35 USC 119(e) of U.S. Application No. 60/849,086, filed Oct. 3, 2006. This application is incorporated herein by reference in its entirety.

### REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

1. Field of the Invention

The present invention relates to an all natural sweetener composition. More specifically, the present invention relates to a zero or low calorie all natural sweetener composition including a polyol such as erythritol, a natural sweetener agent comprised of a blend of oligofructose, fructose, vegetable protein isolate, and natural flavors, maltodextrin and supplemented with calcium, which can be used in beverages, foods and/or food and beverage products to replace or reduce high-calorie sweetener content and provide calcium supplementation.

2. Description of the Related Art

High fructose corn syrup, artificial sweeteners, sugar, obesity, and diabetes are today's biggest health concerns. Health officials and scientists are beginning to understand in particular the link with high fructose corn syrup, artificial sweeteners, and sugar products to obesity, diabetes, and numerous other health concerns. It is estimated that the average American consumes 20 teaspoons a day or more than 150 pounds of sugar per year. Teen consumption is higher at 34 teaspoons of sugar a day. Excessive consumption of sugar, especially by American youth, has experts calling the recent dramatic rise in type 2 diabetes among adolescents an “emerging epidemic.” Further, as a result of excessive refining, sugar is “devoid of vitamins, minerals and fiber.” Accordingly, the statistics are staggering: 129 million adult Americans are overweight, over 60 million are obese or over 30% of the adult population. As a result of these health conditions, there are over 300,000 premature deaths each year. Over 40 million children, including “tweens” and teens are overweight. Many health experts assert that sugar is nutritionally empty and detrimental to human health and many believe it would fail the FDA approval process if such a hypothetical attempt were made today. According to Dr. Robert C. Atkins, founder of the popular Atkins diet, “sugar has no nutritional value and is directly harmful to your health. Despite vociferous attempts to defend it, there are studies that clearly show how harmful (and even deadly in the case of diabetics) its effects can be.” According to Nancy Appleton, Ph.D., author of “Lick the Sugar Habit,” there are 78 metabolic consequences of consuming sugar.

However, diabetes is really only one of the numerous consequences of over-consuming sugar. Dr. John Yudkin, a leading authority on dietary sugars, says that the detrimental effects of excess sugar in the diet go far beyond rotting teeth and obesity. “For example,” Yudkin says, “Sugar causes irregularities in the insulin response; Sugar causes diabetes-like damage to the kidneys; it contributes to degeneration of the retina; it raises blood fat levels and it increases the stickiness of the blood platelets, a common precursor of heart trouble.”

Another health concern today is the lack of calcium supplementation. As we age, our need for certain minerals such as calcium increase due to the lower absorption rate of our aging digestive organs. The lack of adequate calcium and the minerals necessary for calcium's proper absorption have been associated with osteoporosis, colitis, bone fractures, dental health problems, brittleness of nails, insomnia, and bruxism. The body cannot produce calcium, yet it plays a vital role in daily body functions like muscle contraction, relaxation, blood clotting and the transmission of nerve impulses.

The calcium in bones is in a constant state of turnover. When diet does not provide enough, the body draws on the calcium stored in bone to maintain adequate blood levels. Not consuming enough calcium daily can drain calcium from bones, leading to osteoporosis. There is also emerging research evidence that suggests that calcium supplementation can assist in weight-loss.

The most effective way to achieve and sustain healthful weight-loss is by reducing calorie intake. Unfortunately, most humans instinctively are attracted to the sensation of sweetness which makes it more difficult for them to resist eating foods and beverages which contain high-caloric, high glycemic sugars and sweeteners such as, for example, sucrose, fructose, honey, and high-fructose corn syrup. Further, food manufacturers that produce low or reduced fat products often substantially add the sugar or sweetener content of their products to offset the loss of taste and texture often associated with reducing fat content.

One avenue in an attempt to solve these serious health issues is the creation of a zero or low calorie sweetener or sugar substitutes that can be used in foods and/or beverages to replace or reduce high calorie sweeteners, sugar content. Examples of such zero-calorie artificial sweeteners include, for example, aspartame, acesulfame-K, sucralose and saccharin. Low calorie natural sweeteners would include lo han guo and stevia both derived from fruit and roots, respectively. However, not all zero or low calorie sweeteners or sugar substitutes, artificial or natural are suitable for all applications. For example, some sweeteners may be suitable for beverages such as sodas and drink mixes but are not acceptable for use in baked goods because exposure to higher temperatures during baking can reduce the sweetening ability of the sweetener. Some natural sweeteners have a bitter aftertaste and do not render a sweet enough taste or exist in a natural color such as brown or yellow, which conflicts with clear beverages or light colored baked products. As another example, some sweeteners may be suitable for use in solid foods or baked goods but may not work properly for use in beverages and drink mixes due to limitations on solubility or may not have GRAS status (generally recognized as safe as defined by the FDA).

In light of the aforementioned, there is a clear need and a demand for an all natural sweetener composition that meets many of the health and commercial requirements. Specifically, there is a need and a demand for a zero or low calorie all natural sweetener composition that can be utilized in food products such as baked goods, snack foods, dairy products and the like and in beverages and beverage mixes. There is a further need and a demand for an all natural sweetener composition which reduces the risk of tooth decay, is diabetic safe, cooks and tastes like sugar, and includes less than 1 gram of carbohydrates. And there is clearly a need and a demand for an all natural sweetener composition that contains calcium supplementation.

### BRIEF SUMMARY OF THE INVENTION

An objective of the invention is to provide a natural sweetener composition.

An objective of the invention is to provide an all natural, zero or low calorie sweetener composition that may be used in food products and/or beverages to replace or reduce high calorie sugar or sugar sweetener content.

An objective of the invention is to provide a natural sweetener composition that tastes, bakes, and cooks like sugar, is diabetic safe, reduces the risk of tooth decay, includes less than 1 gram of carbohydrates, and provides calcium supplementation.

The object of the invention can be attained, at least in part, through an all natural sweetener composition including a polyol, such as erythritol, an all natural sweetener agent comprised of a blend of oligofructose, fructose, vegetable protein isolate, and natural flavors, maltodextrin and calcium.

In accordance with certain preferred embodiments, the all natural sweetener composition includes erythritol, a blend of oligofructose, fructose, vegetable protein isolate, and natural flavors, maltodextrin and calcium.

In accordance with certain other preferred embodiments, the all natural sweetener composition includes about 70 to about 80 composition weight percent erythritol, about 10 to about 20 composition weight percent of a blend of oligofructose, fructose, vegetable protein isolate, and natural flavors, and about 5 to about 15 composition weight percent maltodextrin, and about 0.5 to about 12 composition weight percent calcium.

In accordance with a further preferred embodiment of the invention, the all natural sweetener composition includes about 74.65 composition weight percent erythritol, about 12.67 composition weight percent of a blend of oligofructose, fructose, vegetable protein isolate, and natural flavors, about 8.45 composition weight percent maltodextrin, and about 4.23 composition weight percent of calcium.

The prior compositions failed to provide a zero or low calorie all natural sweetener composition including a polyol such as erythritol, a reduced calorie sweetener such as a blend of oligofructose, fructose, vegetable protein isolate, natural flavors, maltodextrin, and calcium supplementation, that is as effective as desired in satisfying one or more of the above-identified needs or demands.

Other objects and advantages will be apparent to those skilled in the art from the following description.

### BRIEF DESCRIPTION OF THE SEVERAL VIEWS OF THE DRAWING(S)

Not applicable.

### DETAILED DESCRIPTION OF THE INVENTION

An embodiment of the present invention provides a zero or low calorie all natural sweetener composition suitable for use in food products and/or beverages. Such a natural sweetener composition includes a polyol, such as erythritol, a reduced calorie sweetener a reduced calorie sweetener such as a blend of oligofructose, fructose, vegetable protein isolate, natural flavors, maltodextrin, and calcium supplementation. An embodiment of the present invention further provides a natural sweetener composition having zero calories and containing less than 1 gram of carbohydrates. An embodiment of the present invention additionally provides an all natural sweetener composition that tastes like sugar, bakes like sugar, is diabetic safe, and reduces the risk of tooth decay.

It is particularly desirable in the production of sweeteners and sugar substitutes to develop sweeteners and sweetener compositions that are as similar as possible to sugar in texture, taste, and usability. More specifically, it is particularly desirable to develop sweeteners and sweetener compositions that provide an appropriate level of sweetness, have an appropriate texture and mouthfeel, have a positive impact on product appearance, have limited or no negative aftertaste, and provide flavor enhancing and/or masking abilities, stability, and the ability to brown when baked. However, due to the varying properties of different sweetening ingredients, it is often difficult to achieve as satisfactory of a result when combining such ingredients. This is generally believed to be due to the synergistic effects of mixing various sweetening compounds wherein the sweetness of the mixture is often greater than the apparent sweetness of the individual components. It has now been discovered that an appropriate blend of a polyol such as erythritol, a reduced calorie sweetener, a blend of oligofructose, fructose, vegetable protein isolate, and natural flavors, and maltodextrin, can result in sweetener product that has many of the desirable properties of sugar and calcium which assists supplementing the body with an essential mineral for bone and general health support.

In accordance with an embodiment of the present invention, a natural sweetener composition for use in beverages and/or food products includes erythritol, a blend of oligofructose, fructose, vegetable protein isolate, and natural flavors and maltodextrin. In particular, the natural sweetener composition includes:

about 60 to about 90 composition weight percent erythritol, preferably about 70 to about 80 composition weight percent erythritol;

about 5 to about 35 composition weight percent a blend of oligofructose, fructose, vegetable protein isolate, and natural flavors, preferably about 7 to about 20 composition weight percent a blend of oligofructose, fructose, vegetable protein isolate, and natural flavors;

about 2 to about 30 composition weight percent maltodextrin, preferably about 5 to about 15 composition weight percent maltodextrin; and

about 1 to about 20 composition weight percent calcium, preferably about 2 to about 10 composition weight percent calcium.

The natural sweetener composition may also include additional ingredients, compounds, or sweeteners which may enhance the flavor, stability, and processability of the sweetener composition. For example, the all natural sweetener composition may include an additional sweetener such as a reduced calorie sweetener, a sugar-derived sweetener, or a non-nutritive sweetener. Additionally, the natural sweetener composition may include processing and/or stability aids such as, for example, silica, and/or other flow or preservative agents.

### EXAMPLE 1

| | Composition Weight | Single Serving |
|---|---|---|
| Ingredient | Percent | Weight (g) |
| Erythritol | 74.65 | 2.65 |
| Blend of oligofructose, | 12.67 | 0.45 |
| fructose, vegetable | | |
| protein isolate, and | | |
| natural flavors | | |
| Maltodextrin | 8.45 | 0.30 |
| Calcium | 4.23 | 0.15 |

While in the foregoing specification this invention has been described in relation to certain preferred embodiments thereof, and many details have been set forth for purposes of illustration, it will be apparent to those skilled in the art that the all natural sweetener composition according to this invention is susceptible to additional embodiments and that certain of the details described herein can be varied significantly without departing from the basic principles of the invention.

Further, in accordance with an embodiment of the present invention, an all natural sweetener composition for the primary use in baking food products where the taste and qualities of cane sugar are nearly identical, such as with the use of heat, browning, (maillard reaction), and crystallization (hardening of the sweetener), includes a polyol, such as erythritol, a blend of oligofructose, fructose, vegetable protein isolate, natural flavors, isomaltulose (a low caloric disaccharide derived from sucrose) and calcium. In particular, the natural sweetener composition includes:

about 45 to about 75 composition weight percent erythritol, preferably about 57 to about 67 composition weight percent erythritol;

about 2 to about 20 composition weight percent a blend of oligofructose, fructose, vegetable protein isolate, and natural flavors, preferably about 1 to about 10 composition weight percent a blend of oligofructose, fructose, vegetable protein isolate, and natural flavors;

about 10 to about 35 composition weight percent isomaltulose, preferably about 17 to about 28 composition weight percent isomaltulose; and

about 2 to about 25 composition weight percent calcium, preferably about 2 to about 10 composition weight percent calcium.

The natural sweetener composition may include additional ingredients, compounds or sweeteners which may enhance the flavor, stability, and processability of the sweetener composition. For example, the all natural sweetener composition may include an additional sweetener such as a reduced calorie sweetener, a sugar-derived sweetener, or a non-nutritive sweetener. Additionally, the natural sweetener composition may include processing and/or stability aids such as, for example, silica and/or other flow or preservative agents.

### EXAMPLE 2

| | Composition Weight | Single Serving |
|---|---|---|
| Ingredient | Percent | Weight (g) |
| Erythritol | 62.82 | 2.56 |
| Blend of oligofructose, | 6.75 | 0.275 |
| fructose, vegetable | | |
| protein isolate, and | | |
| natural flavors | | |
| Isomaltulose | 23.07 | 0.94 |
| Calcium | 7.36 | 0.30 |

Further, in accordance with an embodiment of the present invention, an all natural sweetener composition for the primary use in baking food products where the taste and qualities of cane sugar are nearly identical, such as with the use of heat, browning (e.g., maillard reaction), and crystallization (i.e., hardening of the sweetener), includes a polyol, such as erythritol, a blend of oligofructose, fructose, vegetable protein isolate, natural flavors, isomaltulose (a low caloric disaccharide derived from sucrose) and calcium. The unique combination and quantity level of the ingredients allows the invention to claim 40% fewer calories than cane sugar and has been validated by RSSL laboratories based in England to be “low glycemic” as determined by established protocol from the World Health Organization (WHO). In particular, the natural sweetener composition includes:

about 25 to about 50 composition weight percent erythritol, preferably about 32 to about 39 composition weight percent erythritol;

about 1 to about 30 composition weight percent a blend of oligofructose, fructose, vegetable protein isolate, and natural flavors, preferably about 1 to about 10 composition weight percent a blend of oligofructose, fructose, vegetable protein isolate, and natural flavors;

about 20 to about 40 composition weight percent isomaltulose, preferably about 22 to about 30 composition weight percent isomaltulose;

about 1 to about 10 composition weight percent calcium, preferably about 2 to about 7 composition weight percent calcium; and

about 20 to about 40 composition weight percent natural, organic cane sugar (e.g., sucrose), preferably about 22 to about 30 composition weight natural, organic cane sugar (e.g., sucrose).

The natural sweetener composition may include additional ingredients, compounds or sweeteners which may enhance the flavor, stability, and processability of the sweetener composition. For example, the all natural sweetener composition may include an additional sweetener such as a reduced calorie sweetener, a sugar-derived sweetener, or a non-nutritive sweetener. Additionally, the natural sweetener composition may include processing and/or stability aids such as, for example, silica and/or other flow or preservative agents.

### EXAMPLE 3

| | Composition Weight | Single Serving |
|---|---|---|
| Ingredient | Percent | Weight (g) |
| Natural, organic cane | 27.825% | 0.27826 |
| sugar (sucrose) | | |
| Erythritol | 35.856 | 0.35856 |
| Blend of oligofructose, | 4.864% | 0.04864 |
| fructose, vegetable | | |
| protein isolate, and | | |
| natural flavors | | |
| Isomaltulose | 27.825% | 0.27826 |
| Calcium | 3.630 | 0.03630 |

While in the foregoing specification this invention has been described in relation to certain preferred embodiments thereof, and many details have been set forth for purposes of illustration, it will be apparent to those skilled in the art that the all natural sweetener composition according to this invention is susceptible to additional embodiments and that certain of the details described herein can be varied significantly without departing from the basic principles of the invention.

Further, in accordance with an embodiment of the present invention, an all natural sweetener composition for the use with beverage and liquid product applications where the taste and qualities of cane sugar are nearly identical, such as with high heat beverage processing, however, at ten times the sweetness of cane sugar, offers greater cost efficiency, includes an appropriate blend of a polyol such as erythritol, a reduced calorie sweetener, a blend of oligofructose, fructose, vegetable protein isolate, and natural flavors, maltodextrin, and calcium, can result in sweetener product that has many of the desirable properties of sugar without the added calories.

In accordance with an embodiment of the present invention, an all natural sweetener composition for use in beverages and/or food products includes erythritol, a blend of oligofructose, fructose, vegetable protein isolate, and natural flavors and maltodextrin and calcium. In particular, the natural sweetener composition includes:

about 45 to about 75 composition weight percent erythritol, preferably about 55 to about 65 composition weight percent erythritol;

about 15 to about 45 composition weight percent a blend of oligofructose, fructose, vegetable protein isolate, and natural flavors, preferably about 25 to about 35 composition weight percent a blend of oligofructose, fructose, vegetable protein isolate, and natural flavors;

about 1 to about 20 composition weight percent maltodextrin, preferably about 2 to about 12 composition weight percent maltodextrin; and

about 1 to about 20 composition weight percent calcium, preferably about 2 to about 8 composition weight percent calcium.

The all natural sweetener composition may include additional ingredients, compounds or sweeteners which may enhance the flavor, stability, and processability of the sweetener composition. For example, the all natural sweetener composition may include an additional sweetener such as a reduced calorie sweetener, a sugar-derived sweetener, or a non-nutritive sweetener. Additionally, the natural sweetener composition may include processing and/or stability aids such as, for example, silica and/or other flow or preservative agents.

### EXAMPLE 4

| | Composition Weight | Single Serving |
|---|---|---|
| Ingredient | Percent | Weight (g) |
| Erythritol | 59.77 | 1.59 |
| Blend of oligofructose, | 30.08 | 0.8 |
| fructose, vegetable | | |
| protein isolate, and | | |
| natural flavors | | |
| Maltodextrin | 6.77 | 0.18 |
| Calcium | 3.38 | 0.09 |

While in the foregoing specification this invention has been described in relation to certain preferred embodiments thereof, and many details have been set forth for purposes of illustration, it will be apparent to those skilled in the art that the all natural sweetener composition according to this invention is susceptible to additional embodiments and that certain of the details described herein can be varied significantly without departing from the basic principles of the invention.

Further, in accordance with an embodiment of the present invention, an all natural sweetener composition for the primary use in commercial food product applications where the taste and qualities of cane sugar are nearly identical, such as with the use of high heat processing, baking, browning, (maillard reaction), and crystallization (hardening of the sweetener), or with any non-liquid food applications, however, at ten times the sweetness of cane sugar, offers greater cost efficiency, includes an appropriate blend of a polyol such as erythritol, a reduced calorie sweetener, a blend of oligofructose, fructose, vegetable protein isolate, and natural flavors, isomaltulose, and calcium, can result in sweetener product that has many of the desirable properties of sugar without the added calories.

In accordance with an embodiment of the present invention, an all natural sweetener composition for use in beverages and/or food products includes erythritol, a blend of oligofructose, fructose, vegetable protein isolate, and natural flavors and maltodextrin and calcium. In particular, the natural sweetener composition includes:

about 25 to about 60 composition weight percent erythritol, preferably about 30 to about 45 composition weight percent erythritol;

about 15 to about 45 composition weight percent a blend of oligofructose, fructose, vegetable protein isolate, and natural flavors, preferably about 25 to about 35 composition weight percent a blend of oligofructose, fructose, vegetable protein isolate, and natural flavors;

about 1 to about 30 composition weight percent isomaltulose, preferably about 4 to about 24 composition weight percent; and

about 1 to about 15 composition weight percent calcium, preferably about 2 to about 8 composition weight percent calcium.

The all natural sweetener composition may include additional ingredients, compounds or sweeteners which may enhance the flavor, stability, and processability of the sweetener composition. For example, the all natural sweetener composition may include an additional sweetener such as a reduced calorie sweetener, a sugar-derived sweetener, or a non-nutritive sweetener. Additionally, the natural sweetener composition may include processing and/or stability aids such as, for example, silica and/or other flow or preservative agents.

### EXAMPLE 5

| | Composition Weight | Single Serving |
|---|---|---|
| Ingredient | Percent | Weight (g) |
| Erythritol | 37.69 | 1.54 |
| Blend of oligofructose, | 30.08 | 0.8 |
| fructose, vegetable | | |
| protein isolate, and | | |
| natural flavors | | |
| Isomaltulose | 13.84 | 0.56 |
| Calcium | 4.42 | 0.18 |

Further, in accordance with an embodiment of the present invention, an all natural sweetener composition for the primary use in commercial food and beverage product applications where the taste and qualities of cane sugar are nearly identical, such as with the use of heat, browning, (maillard reaction), and crystallization (hardening of the sweetener), high heat beverage processing, however, at ten times the sweetness of cane sugar, offers greater cost efficiency, includes an appropriate blend of a polyol such as erythritol, a reduced calorie sweetener, a blend of oligofructose, fructose, vegetable protein isolate, and natural flavors, maltodextrin, and calcium, can result in sweetener product that has many of the desirable properties of sugar without the added calories.

In accordance with an embodiment of the present invention, an all natural sweetener composition for use in beverages and/or food products includes erythritol, a blend of oligofructose, fructose, vegetable protein isolate, and natural flavors and maltodextrin and calcium. In particular, the natural sweetener composition includes:

about 1 to about 35 composition weight percent erythritol, preferably about 5 to about 15 composition weight percent erythritol;

about 65 to about 95 composition weight percent a blend of oligofructose, fructose, vegetable protein isolate, and natural flavors, preferably about 78 to about 88 composition weight percent a blend of oligofructose, fructose, vegetable protein isolate, and natural flavors;

about 1 to about 20 composition weight percent maltodextrin, preferably about 2 to about 12 composition weight percent maltodextrin; and

about 1 to about 20 composition weight percent calcium, preferably about 2 to about 8 composition weight percent calcium.

Emerging clinical research has begun to establish a direct link and enhancement of calcium absorption when combined with oligofructose is derived from insulin. Human studies are increasing, with a significant number of studies into the role of oligofructose's enhancement of calcium consumption and on the improvement of bone health of adolescent girls. One such study reported that girls and boys aged between 9 and 12 supplemented with a mixture of oligofructose and long-chain inulin had an additional net accretion of calcium of 30 milligrams per day, compared to the controls who received a placebo (American Journal of Clinical Nutrition, 2005, Vol. 82, pp. 471-476).

Osteoporosis is estimated to affect about 75 million people in Europe, the USA and Japan. According to the International Osteoporosis Foundation, the total annual direct cost of osteoporotic fractures is $17.5 billion in the US (2002 figure).

The all natural sweetener composition may include additional ingredients, compounds or sweeteners which may enhance the flavor, stability, and processability of the sweetener composition. For example, the all natural sweetener composition may include an additional sweetener such as a reduced calorie sweetener, a sugar-derived sweetener, or a non-nutritive sweetener. Additionally, the natural sweetener composition may include processing and/or stability aids such as, for example, silica and/or other flow or preservative agents.

### EXAMPLE 6

| | Composition Weight | Single Serving |
|---|---|---|
| Ingredient | Percent | Weight (g) |
| Erythritol | 10.44 | 1.59 |
| Blend of oligofructose, | 82.40 | 0.8 |
| fructose, vegetable | | |
| protein isolate, and | | |
| natural flavors | | |
| Maltodextrin | 4.75 | 0.18 |
| Calcium | 2.37 | 0.09 |

While in the foregoing specification this invention has been described in relation to certain preferred embodiments thereof, and many details have been set forth for purposes of illustration, it will be apparent to those skilled in the art that the all natural sweetener composition according to this invention is susceptible to additional embodiments and that certain of the details described herein can be varied significantly without departing from the basic principles of the invention.

### Special Blending Protocol in the Manufacturing Process

For the full benefit of the sweetness level and for all of characteristics to be realized for these products, it is recommended that the smallest amount ingredient be mixed with the next larger amount until fully blended. Then the next largest ingredient is added to the combined blend until it is fully dispersed. Then the next largest ingredient is added after that, and this protocol is continued until all ingredients are blended. This assures maximum dispersion of all elements.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A sweetener compositions comprising:
(a) about 45 to 75 wt. % erythritol;
(b) about 2 to 20 wt. % blend of oligofructose, fructose, vegetable protein isolate, and natural flavors;
(c) about 1 to 35 wt. % isomaltulose; and
(d) about 2 to 25 wt. % calcium.

2. The composition of claim 1 wherein the sweetener composition further comprises an additional sweetener selected from the group consisting of a reduced calorie sweetener, sugar-derived sweetener, or a non-nutritive sweetener.

3. The composition of claim 1 wherein the sweetener further comprises silica.

4. The composition of claim 1 wherein the sweetener further comprises preservative agents.

5. A sweetener composition, comprising:
(a) about 25 to 50 wt. % erythritol;
(b) about 1 to 30 wt. % blend of oligofructose, fructose, vegetable protein isolate, and natural flavors;
(c) about 1 to 40 wt. % isomaltulose;
(d) about 1 to 10 wt. % calcium; and
(e) about 20 to 40 wt. % natural, organic cane sugar.

6. The composition of claim 5 wherein the sweetener composition further comprises an additional sweetener selected from the group consisting of a reduced calorie sweetener, sugar-derived sweetener, or a non-nutritive sweetener.

7. The composition of claim 5 wherein the sweetener further comprises silica.

8. The composition of claim 5 wherein the sweetener further comprises preservative agents.

9. A sweetener composition, comprising:
(a) about 45 to 75 wt. % erythritol;
(b) about 15 to 45 wt. % blend of oligofructose, fructose, vegetable protein isolate, and natural flavors;
(c) about 1 to 20 wt. % maltodextrin; and
(d) about 1 to 20 wt. % calcium.

10. The composition of claim 9 wherein the sweetener composition further comprises an additional sweetener selected from the group consisting of a reduced calorie sweetener, sugar-derived sweetener, or a non-nutritive sweetener.

11. The composition of claim 9 wherein the sweetener further comprises silica.

12. The composition of claim 9 wherein the sweetener further comprises preservative agents.

13. A sweetener composition, comprising:
(a) about 30 to 65 wt. % erythritol;
(b) about 15 to 45 wt. % blend of oligofructose, fructose, vegetable protein isolate, and natural flavors;
(c) about 1 to 30 wt. % maltodextrin; and
(d) about 1 to 15 wt. % calcium.

14. The composition of claim 13 wherein the sweetener composition further comprises an additional sweetener selected from the group consisting of a reduced calorie sweetener, sugar-derived sweetener, or a non-nutritive sweetener.

15. The composition of claim 13 wherein the sweetener further comprises silica.

16. The composition of claim 13 wherein the sweetener further comprises preservative agents.

17. A sweetener compositions comprising:
(a) about 3 to 25 wt. % erythritol;
(b) about 70 to 100 wt. % blend of oligofructose, fructose, vegetable protein isolate, and natural flavors;
(c) about 1 to 20 wt. % maltodextrin; and
(d) about 0.5 to 10 wt. % calcium.

18. The composition of claim 17 wherein the sweetener composition further comprises an additional sweetener selected from the group consisting of a reduced calorie sweetener, sugar-derived sweetener, or a non-nutritive sweetener.

19. The composition of claim 17 wherein the sweetener further comprises silica.

20. The composition of claim 17 wherein the sweetener further comprises preservative agents.

21. A sweetener composition, comprising:
(a) about 60 to 90 wt. % erythritol;
(b) about 5 to 35 wt. % blend of oligofructose, fructose, vegetable protein isolate, and natural flavors;
(c) about 2 to 30 wt. % maltodextrin; and
(d) about 1 to 20 wt. % calcium.

22. The composition of claim 21 wherein the sweetener composition further comprises an additional sweetener selected from the group consisting of a reduced calorie sweetener, sugar-derived sweetener, or a non-nutritive sweetener.

23. The composition of claim 21 wherein the sweetener further comprises silica.

24. The composition of claim 21 wherein the sweetener further comprises preservative agents.

25. A sweetener composition, comprising:
(a) about 1 to 35 wt. % erythritol;
(b) about 65 to 95 wt. % blend of oligofructose, fructose, vegetable protein isolate, and natural flavors;
(c) about 1 to 20 wt. % maltodextrin; and
(d) about 1 to 20 wt. % calcium.

26. The composition of claim 1 wherein the sweetener comprises about 57 to 67 wt. % erythritol.

27. The composition of claim 1 wherein the sweetener comprises about 1 to 10 wt. % blend of oligofructose, fructose, vegetable protein isolate, and natural flavors.

28. The composition of claim 1 wherein the sweetener comprises about 17 to 28 wt. % isomaltulose.

29. The composition of claim 1 wherein the sweetener comprises about 2 to 10 wt. % calcium.

30. The composition of claim 5 wherein the sweetener comprises about 32 to 39 wt. % erythritol.

31. The composition of claim 5 wherein the sweetener comprises about 1 to 10 wt. % blend of oligofructose, fructose, vegetable protein isolate, and natural flavors.

32. The composition of claim 5 wherein the sweetener comprises about 22 to 30 wt. % isomaltulose.

33. The composition of claim 5 wherein the sweetener comprises about 2 to 7 wt. % calcium.

34. The composition of claim 5 wherein the sweetener comprises about 22 to 30 wt. % natural, organic cane sugar.

35. The composition of claim 9 wherein the sweetener comprises about 55 to 65 wt. % erythritol.

36. The composition of claim 9 wherein the sweetener comprises about 25 to 35 wt. % blend of oligofructose, fructose, vegetable protein isolate, and natural flavors.

37. The composition of claim 9 wherein the sweetener comprises about 2 to 12 wt. % maltodextrin.

38. The composition of claim 9 wherein the sweetener comprises about 2 to 8 wt. % calcium.

39. The composition of claim 13 wherein the sweetener comprises about 45 to 55 wt. % erythritol.

40. The composition of claim 13 wherein the sweetener comprises about 25 to 35 wt. % blend of oligofructose, fructose, vegetable protein isolate, and natural flavors.

41. The composition of claim 13 wherein the sweetener comprises about 4 to 24 wt. % maltodextrin.

42. The composition of claim 13 wherein the sweetener comprises about 2 to 8 wt. % calcium.

43. The composition of claim 17 wherein the sweetener comprises about 5 to 15 wt. % erythritol.

44. The composition of claim 17 wherein the sweetener comprises about 77 to 85 wt. % blend of oligofructose, fructose, vegetable protein isolate, and natural flavors.

45. The composition of claim 17 wherein the sweetener comprises about 2 to 8 wt. % maltodextrin.

46. The composition of claim 17 wherein the sweetener comprises about 1 to 7 wt. % calcium.

47. The composition of claim 21 wherein the sweetener comprises about 70 to 80 wt. % erythritol.

48. The composition of claim 21 wherein the sweetener comprises about 7 to 20 wt. % blend of oligofructose, fructose, vegetable protein isolate, and natural flavors.

49. The composition of claim 21 wherein the sweetener comprises about 5 to 15 wt. % maltodextrin.

50. The composition of claim 21 wherein the sweetener comprises about 2 to 10 wt. % calcium.

51. The composition of claim 25 wherein the sweetener comprises about 5 to 15 wt. % erythritol.

52. The composition of claim 25 wherein the sweetener comprises about 78 to 88 wt. % blend of oligofructose, fructose, vegetable protein isolate, and natural flavors.

53. The composition of claim 25 wherein the sweetener comprises about 2 to 12 wt. % maltodextrin.

54. The composition of claim 25 wherein the sweetener comprises about 2 to 8 wt. % calcium.
